(19) United States
(12) Patent Application Publication
(10) Pub. No.: US 2010/0087979 A1
(43) Pub. Date: Apr. 8, 2010

(54) METHOD FOR COOLING COMPONENTS OF A MOTOR VEHICLE

(76) Inventors: Eva Neusinger, Ludwigsburg (DE); Mirko Thulke, Ditzingen (DE)

Correspondence Address: KENYON & KENYON LLP, ONE BROADWAY, NEW YORK, NY, 10004, US

(21) Appl. No.: 12/599,016

(22) PCT Filed: May 5, 2008
(86) PCT No.: PCT/EP08/55452

§ 371 Date: Nov. 5, 2009

(30) Foreign Application Priority Data
May 15, 2007 (DE) 102007022855.6

(51) Int. Cl. G06F 19/00

(52) U.S. Cl. 701/22

(57) ABSTRACT

A method for cooling components of a motor vehicle, the instantaneous cooling capacity being ascertained from an overall cooling requirement, and the overall cooling requirement being composed of the individual cooling requirements of the components. The motor vehicle is driven using an hybrid drive, which has at least one internal combustion engine and at least one electric machine, the electric machine being controlled by a power electronics system; and an electric machine cooling requirement and a power electronics cooling requirement are taken into account, as individual cooling requirements, in the ascertainment of the overall cooling requirement.

### FIELD OF THE INVENTION

The present invention relates to a method for cooling components of a motor vehicle, the instantaneous cooling power being ascertained from an overall cooling requirement, and the overall cooling requirement being composed of the individual cooling requirements of the components.

### BACKGROUND INFORMATION

In conventional motor vehicles, an individual cooling requirement of an internal combustion engine, of a transmission and/or an air conditioning system, as well supercharger cooling, if necessary, are taken into account. The temperature of a cooling medium of a cooling medium circulation system of the motor vehicle and/or a cooling air flow through the engine compartment of the motor vehicle is set as a function of the individual cooling requirements, for example. For this purpose, using suitable logic control pulses, for instance, a radiator fan and/or a thermostat of the motor vehicle is controlled by a control unit or a control device. In this way, on the one hand, the cooling medium temperature, and thus, the temperature of the components of the motor vehicle installed in the coolant circulation circuit, that are to be cooled, may be regulated. On the other hand, sufficient air circulation in the engine compartment, and thus the cooling also of components that are not integrated into the coolant circulation circuit may be assured.

### SUMMARY

The present invention provides that the motor vehicle is driven using an hybrid drive which has at least one internal combustion engine and at least one electric machine, the electric machine being controlled by power electronics; and that, in ascertaining the overall cooling requirement, an electric machine cooling requirement and/or a power electronics cooling requirement are taken into account as individual cooling requirements. Thus, it is provided that individual cooling requirements of the electric machine and/or of the power electronics, of the motor vehicle that is operated using an hybrid drive, be taken into account in the ascertainment of the instantaneous cooling capacity and the determination of the overall cooling requirement. This ensures that the electric machine and/or the power electronics of the hybrid drive are also sufficiently cooled, even when these components are not directly integrated into a coolant circulation circuit of the motor vehicle. Sufficient cooling of the electrical/electronic components of the motor vehicle or of the hybrid drive is thus assured.

The power electronics system expediently has at least one pulse-controlled inverter, using which the electric machine is able to be driven. Overheating of the pulse-controlled inverter is prevented by the advantageous method, and it is advantageously provided that the pulse-controlled inverter works in an advantageous temperature range.

Furthermore, the power electronics system advantageously has at least one DCDC converter. The DCDC converter, also known as a DC motor controller, is sufficiently cooled based on the advantageous method, or held in an advantageous temperature range. If the power electronics system has both the pulse-controlled inverter and the DCDC converter, then, during the determination of the power electronics cooling requirement, individual cooling requirements of the pulse-controlled inverter and/or the DCDC converter are taken into consideration.

According to one refinement of the present invention, the operating state of the electric machine is taken into account for the determination of the electric machine cooling requirement. In particular, the operating temperature of the electric machine is recorded and used for the determination of the electric machine cooling requirement. Additional factors determining the operating state of the electric machine are preferably taken into account, such as a current load of the electric machine and/or its current rotational speed. It is particularly preferred that, as the operating state factor, the operating state of the electric machine or the hybrid drive is taken into account, the operating state describing the driving program in which the hybrid drive currently exists. Thus, for example, the hybrid drive and particularly the electric machine may be in an electrical vehicle operation or in a boost vehicle operation. The different vehicle operations or the operating status, in this context, act directly on the individual cooling requirement of the electric machine (electric machine cooling requirement). By taking into account the operating state or one or more factors defining the operating state of the electric machine, the functioning of the hybrid drive is ensured over time.

To determine the power electronics cooling requirement, the operating state of the power electronics is expediently taken into account. In one advantageous refinement it is provided that, for the determination of the power electronics cooling requirement, the operating state of the pulse-controlled inverter is taken into account. In particular, the current operating temperature of the power electronics, of the pulse-controlled inverter and/or gradients of the temperature of the pulse-controlled inverter are taken into account in this instance.

If the power electronics system has a DCDC converter, the operating state of the DCDC converter is advantageously taken into consideration for the determination of the power electronics cooling requirement. The operating state of the DCDC converter being defined particularly by its current operating temperature and/or its current (electrical) load.

For the determination of an individual requirement, characteristic values, characteristics curves and/or characteristics maps of the components of the motor vehicle are advantageously used, which are expediently ascertained ahead of time and are stored, for example, in a nonvolatile memory of a control unit of the motor vehicle. The determination of an individual cooling requirements is simplified and speeded up by the use of characteristics values, characteristics curves and/or characteristics maps.

In addition, it is provided that, for the determination of an individual cooling requirements, the environmental air temperature and/or the environmental pressure of the motor vehicle, particularly of the hybrid drive of the motor vehicle, be taken into account. By doing this, the current cooling capacity is adapted to outside conditions, so that the components of the motor vehicle are cooled in an especially efficient manner.

In order to determine an individual cooling requirements, in addition or alternatively, the speed of the motor vehicle is advantageously taken into consideration. The vehicle speed particularly has an influence on the air circulating and/or flowing through the engine compartment. That is, the flowing through or the flowing about components of the motor vehicle that are to be cooled is also taken into account.

Finally, it is provided that the individual cooling requirements of at least one component of the motor vehicle be explicitly specified. This means that at least one component emits a signal that is equivalent to the individual cooling requirement of the component, so that it does not first have to be ascertained, for instance, from the control unit of the motor vehicle, from the signals emitted by the component that describe its operating state.

### BRIEF DESCRIPTION OF THE DRAWINGS

The present invention is explained below in greater detail in light of some example embodiments.

FIG. 1 shows a schematic representation of an example method according to the present invention.

FIG. 2 shows a schematic representation of the determination of individual cooling requirements.

### DETAILED DESCRIPTION OF EXAMPLE EMBODIMENTS

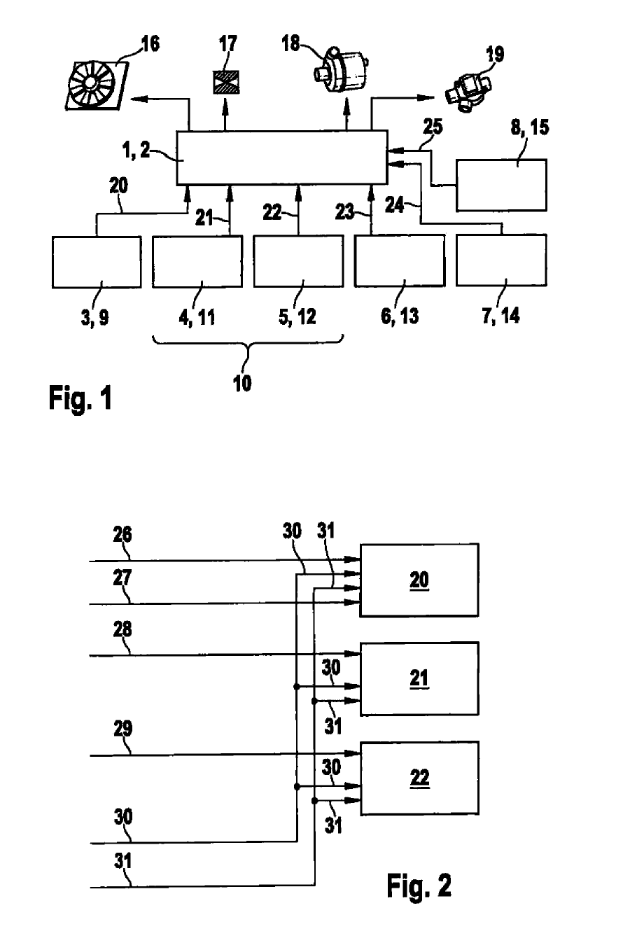

In a schematic block diagram, FIG. 1 shows an example method, according to the present invention, for cooling components of a motor vehicle operated using an hybrid drive. FIG. 1 shows a block 1, which represents a logic part 2, for instance, of a control unit of the motor vehicle. Logic part 2 is operatively connected to a plurality of components 3, 4, 5, 6, 7 and 8, shown by blocks, of the motor vehicle, that are to be cooled. In the present exemplary embodiment, block 3 represents an electric machine 9, which is able to be operated both as a motor and as a generator. In order to ensure the full functional capability of electric machine 9 during the entire operating duration of the motor vehicle, sufficient cooling is required. Electric machine 9 is controlled by power electronics 10, which has a DCDC converter 11, represented by block 4, and a pulse-controlled inverter 12, shown by block 5. Block 5 represents an internal combustion engine 13 and block 7 represents an air conditioning system 14 of the motor vehicle. Block 8 represents an energy store 15, which stores energy generated by electric machine 9 in the operation as a generator, and which provides stored energy to electric machine 9 in the operation as a motor. Moreover, a radiator fan 16, an electronically controlled thermostat 17, a additional water pump 18 and a three-way valve 19 are shown, which are controlled by logic part 2, thermostat 17, three-way valve 19 and additional water pump 18 being parts of a coolant circulation circuit of the motor vehicle, the coolant circulation circuit being able to have a plurality of branches.

Logic part 2 determines an instantaneous cooling capacity from an overall cooling requirement, and appropriately controls radiator fan 16, thermostat 17, additional water pump 18 and/or three-way valve 19, in order to produce this cooling capacity, so that all components 3 to 8 of the motor vehicle are adequately cooled. Individual cooling requirements, characterized by arrows 20 to 25 of components 3 to 8 are taken into account in this context. In particular, an electric machine cooling requirement 20 and a power electronics cooling requirement 21, 22 are taken into account, in this connection. This also ensures a sufficient cooling of the electrical/electronic components 3 to 5 of the motor vehicle. The individual cooling requirements 20 to 25 may be specified either by components 3 to 8 explicitly to logic part 2, whereby the instantaneous/instantaneously required cooling capacity is able to be set particularly rapidly, or they are ascertained/determined with the aid of operating state data supplied by components 3 to 8.

FIG. 2 shows schematically an exemplary embodiment for determining individual cooling requirements 20, 21 and 22 of electric machine 9, of DCDC converter 11 and of pulse-controlled inverter 12. In the determination of individual cooling requirement 20 or of the electric machine cooling requirement, the instantaneous temperature of the electric machine, characterized by arrow 26, as well as the current rotational speed, characterized by arrow 27 are taken into account, so that individual cooling requirement 20 is determined as a function of current temperature 26 and rotational speed 27. It is conceivable, of course, to take into account still further factors describing the operating state of electric machine 9 during the determination of individual cooling requirement 20, or rather the electric machine cooling requirement, such as, for instance, a current mechanical and/or electrical load.

For the determination of individual cooling requirement 21 of DCDC converter 11, its operating state, described by its current operating temperature is taken into account, characterized by arrow 28. For the determination of individual cooling requirement 22 of pulse-controlled inverter 12, its operating state, expressed by its current operating temperature is taken into account, characterized by arrow 29.

In addition to the factors that describe the respective operating states, which were mentioned above, in the determination of individual cooling requirements 20, 21 and 22, the current environmental temperature, characterized by arrows 30, as well as the current environmental pressure, characterized by arrows 31, are taken into account. The cooling capacity is thereby able to be adjusted individually to the currently prevailing environmental conditions.

In the determination of individual cooling requirements 20 to 25, characteristics values, characteristics curves and/or characteristics maps of respective components 3 to 8, ascertained ahead of time, may be used. This makes possible an especially simple and effective determination of individual cooling requirements 20 to 25. In the determination of individual cooling requirements 20 to 25 and/or in the determination of the overall cooling requirement by logic part 2, the vehicle speed of the motor vehicle may advantageously be additionally taken into account, which has an effect on the air circulating/flowing in the engine compartment of the motor vehicle. Of course, in determining the overall cooling requirement, additional components of the motor vehicle that are to be cooled, such as energy store 15, that is operationally connected to electric machine 9, may be taken into account. In determining the cooling capacity, the current temperature of the cooling medium of the one, or the plurality of coolant circulation circuits is included. In addition, the temperature of the transmission oil of a transmission of the hybrid drive as well as the air conditioner compressor pressure of an air conditioning system may also be included. In principle, it makes no difference whether water cooling or air cooling is involved in the coolant circulation circuit.

1-10. (canceled)

11. A method for cooling components of a motor vehicle driven using a hybrid drive which has at least one internal combustion engine and at least one electric machine, the electric machine being controlled by a power electronics system, the method comprising:
ascertaining an instantaneous cooling requirement from an overall cooling requirement, the overall cooling requirement being composed of individual cooling requirements of individual components; and
taking into account at least one of an electric machine cooling requirement and a power electronics cooling requirement as individual cooling requirements, in the ascertainment of the overall cooling requirement.

12. The method as recited in claim 11, wherein the power electronics system has at least one pulse-controlled inverter.

13. The method as recited in claim 11, wherein the power electronics system has at least one DCDC converter.

14. The method as recited in claim 11, wherein an operating state of the electric machine is taken into account for a determination of a cooling requirement of the electric machine.

15. The method as recited in claim 11, wherein an operating state of the power electronics is taken into account for a determination of a cooling requirement of the power electronics.

16. The method as recited in claim 11, wherein the power electronics system includes at least one pulse-controlled inverter, and an operating state of the pulse-controlled inverter is taken into account for a determination of a cooling requirement of the power electronics.

17. The method as recited in claim 11, wherein the power electronics system has at least one DCDC converter, and an operating state of the DCDC converter is taken into account for a determination of a cooling requirement of the power electronics.

18. The method as recited in claim 11, wherein at least one of characteristics values, characteristics curves and characteristics maps are used for the determination of an individual cooling requirement.

19. The method as recited in claim 11, wherein at least one of an environmental air temperature and an environmental pressure of the hybrid drive is taken into account for a determination of at least one of an individual cooling requirement and the overall cooling requirement.

20. The method as recited in claim 11, wherein a vehicle speed of the motor vehicle is taken into account for a determination of an individual cooling requirement and the overall cooling requirement.

21. The method as recited in claim 11, wherein the individual cooling requirement of at least one component of the motor vehicle that is to be cooled is specified by the component.
